(19) United States
(12) Patent Application Publication
(10) Pub. No.: US 2008/0199247 A1
(43) Pub. Date: Aug. 21, 2008

(54) Ball and Socket Joint for a Motor Vehicle

(76) Inventors: Joachim Spratte, Osnabruck (DE); Michael Klank, Osnabruck (DE); Jochen Kruse, Osnabruck (DE)

Correspondence Address: MCGLEW & TUTTLE, PC, P.O. BOX 9227, SCARBOROUGH STATION, SCARBOROUGH, NY, 10510-9227, US

(21) Appl. No.: 11/996,159

(22) PCT Filed: Jul. 3, 2006
(86) PCT No.: PCT/DE2006/001150

§ 371 Date: Apr. 28, 2008

(30) Foreign Application Priority Data
Jul. 19, 2005 (DE) 10 2005 034 150.0

(51) Int. Cl. F16C 11/06; G06F 17/00

(52) U.S. Cl. 403/27; 700/70

(57) ABSTRACT

A ball and socket joint for a motor vehicle is provided with a joint housing (2), with a ball pivot (3), which is mounted rotatably and pivotably in same and which is in contact with the joint housing (2) or with a ball shell (7) arranged between this and the ball pivot (5). The ball and socket joint has an angle measuring device (20, 21), by which the angle of the ball pivot (5) relative to the joint housing (2) can be detected. At least two temperature sensors (15, 16) are arranged at spaced locations from one another in or on the joint housing (2).

### CROSS REFERENCE TO RELATED APPLICATIONS

This application is a United States National Phase application of International Application PCT/DE 2006/001150 and claims the benefit of priority under 35 U.S.C. § 119 of German Patent Application DE 10 2005 034 150.0 filed Jul. 19, 2005, the entire contents of which are incorporated herein by reference.

### FIELD OF THE INVENTION

The present invention pertains to a ball and socket joint for a motor vehicle, with a joint housing; with a ball pivot, which is mounted rotatably and pivotably in same and which is in contact with the joint housing or with a ball shell arranged between this and the ball pivot; and with an angle measuring device, by means of which the angle of the ball pivot relative to the joint housing can be detected. The present invention pertains, furthermore, to a process for determining a wear indicator characterizing the wear of a ball and socket joint.

### BACKGROUND OF THE INVENTION

Thermal and/or mechanical overloading of a ball and socket joint leads to a change in the “tribological conditions” in the joint, and the change may be due, e.g., to hardening of the lubricating grease or to wear of the ball shell. This overloading cannot be measured online in the measuring device or on the test bench. Only the measurement of the elasticity of the joints on a test bench is possible. It is only in case of very great wear of the ball and socket joint that a free clearance develops in the joint and “unbuttoning” of the joint develops later. It is not yet possible to determine a premature wear in the motor vehicle.

### SUMMARY OF THE INVENTION

The object of the present invention is to perfect a ball and socket joint of the type mentioned above such that a wear indicator characterizing the wear of the ball and socket joint can be determined.

The ball and socket joint according to the present invention for a motor vehicle has a joint housing; a ball pivot, which is mounted rotatably and pivotably in this and which is in contact with the joint housing or with a ball shell arranged between this and the ball pivot; and an angle measuring device, by means of which the angle of the ball pivot relative to the joint housing can be detected, wherein at least two temperature sensors are arranged at mutually spaced locations from one another in or on the joint housing. The ball pivot has especially a pin and a joint ball, which is connected to same and which is preferably lubricated with a lubricant introduced into the joint housing, e.g., grease. Furthermore, the ball shell may be a one-part or multipart shell.

During a motion of the ball pivot relative to the joint housing, heat is generated by friction, and this heat leads to a heat flux in the joint. It was found that the quotient of the difference between temperature values detected at two different sites and the angular velocity of the ball pivot relative to the joint housing is an indicator of the wear of the joint. Thus, the quotient forms a wear indicator, which can also be determined in the motor vehicle, the angular velocity being able to be determined by differentiation over time of the angle values determined by the angle measuring device and the two temperature values being able to be detected by the temperature sensors.

The course of the frictional heat flux generated by a motion of the ball pivot relative to the housing can be determined or at least estimated, and the temperature sensors are preferably seated in different positions in this frictional heat flux. However, the two temperature sensors have, in particular, different distances from the center of the joint ball or a spherical bearing surface of the housing or ball shell.

The temperature sensors may be arranged in or on the ball shell and/or in or on the wall of the housing. However, the two temperature sensors are preferably seated on a plate or printed circuit board arranged in or on the joint housing and are provided, in particular, on mutually opposite sides of this plate or printed circuit board.

The housing has an opening, through which the ball pivot extends, the area of the housing located opposite the opening preferably comprising a bottom, on which, e.g., the ball shell is supported. The temperature sensors are arranged especially in the area of the bottom, so that the plate or printed circuit board is preferably also seated in the area of the bottom. Furthermore, the bottom may have an opening, which is closed by a cover, by which the plate or printed circuit board is held or formed.

The angle measuring device is preferably designed as a magnetic angle measuring device and has a magnet with a magnetic field-sensitive sensor cooperating with this. The magnet may be designed as a permanent magnet or the magnetic field-sensitive sensor may be designed as a magnetoresistive sensor or as a Hall effect sensor. In particular, the magnet is fastened to the ball pivot and the magnetic field-sensitive sensor to the housing. However, a reversed arrangement is possible as well.

Furthermore, the angle measuring device is connected especially at least indirectly to the ball and socket joint and may be arranged outside same. However, the angle measuring device is preferably provided in or on the ball and socket joint or the ball and socket joint housing and is especially integrated in the ball and socket joint. Thus, a highly compact measuring set-up can be obtained, on the whole, which is protected by the joint housing and optionally by the cover from external effects.

Upon closer examination, a force exerted by the ball pivot on the joint housing or on the ball shell may be additionally included in the wear indicator. It was found, in particular, that the above-mentioned quotient can be formed by dividing the temperature difference by the product of the angular velocity and this force. The force exerted by the ball pivot on the joint housing or on the ball shell can therefore preferably be determined by at least one force sensor.

The measurement of the angle is, however, more important than the measurement of the force. If the ball and socket joint is arranged in the wheel suspension of a motor vehicle, the force can also be estimated from the weight of the vehicle and the extent of jouncing, which can be determined from the measured angle. Thus, the angle measuring device can also be used as a force sensor. It is even possible to assume or set the force as a constant in the simplest case.

The force sensor is connected especially at least indirectly to the ball and socket joint and may be arranged outside same. However, the force sensor is preferably provided in or on the ball and socket joint or the ball and socket joint housing, and it is especially integrated in the ball and socket joint. Furthermore, the force sensor may be formed by a piezoelectric sensor.

To determine the wear indicator, the two temperature sensors, the angle measuring device and optionally the force sensor are preferably provided with an analyzing means, by which the wear indicator characterizing the wear of the ball and socket joint can be determined. The analyzing means has, in particular, a differentiator, which is connected to the angle measuring device; a difference former connected to the two temperature sensors, and a calculating unit, which is arranged downstream of the differentiator and the difference former and is optionally connected to the force sensor, wherein the difference former may be designed as a differential amplifier. The calculating unit may comprise at least one (first) divider and preferably additionally has a multiplier and/or a second divider.

The analyzing means may be designed by means of analog or digital assembly units. However, the analyzing means is preferably formed by at least one digital computer, in which a program is stored, by means of which the signals measured by the angle measuring device, the temperature sensors and optionally the force sensor can be processed to determine the wear indicator.

The present invention also pertains to a motor vehicle with a vehicle body, with a motor vehicle component connected to the vehicle body and with at least one ball and socket joint according to the present invention, which is connected to the motor vehicle component. The ball and socket joint may be varied according to all the aforementioned embodiments. The motor vehicle component is preferably formed by a chassis component, such as a track rod, or a control arm, especially by an upper or lower suspension arm.

The present invention pertains, furthermore, to a process for determining a wear indicator characterizing the wear of a ball and socket joint having a joint housing and a ball pivot mounted rotatably and pivotably in this and/or to the use of the ball and socket joint according to the present invention for determining the wear indicator by
determining angle data by consecutive measurement of the angle between the ball pivot and the joint housing,
determining an (angular) velocity by differentiating the angle data over time, measuring temperatures at least two different sites in or on the ball and socket joint, and
determining the wear indicator on the basis of the angular velocity and the temperature values.

The ball and socket joint may be varied according to all the above-mentioned embodiments. The term “data” shall refer here to the preferred use of a digital computer for carrying out the process. However, it is possible that the term “data” designates one or more values that are available as analog or digital signals, without a computer being used.

The wear indicator is preferably also multiplied by a joint-specific constant and divided by the radius of the joint ball.

In particular, a force exerted by the ball pivot on the joint housing or on a ball shell arranged between this and the joint housing is measured and the wear indicator is additionally determined on the basis of the measured force.

Since the ball shell is usually received and held by the joint housing, the force exerted by the ball pivot on the joint housing corresponds essentially to the force exerted by the ball pivot on the ball shell and can be derived from this.

It is possible, in principle, to modify the angle, the angle data, the angular velocity, optionally the force, the temperature values, the difference and/or the wear indicator with suitable factors, and additional assembly units may be provided for this. If the analyzing means is formed by a digital computer, these additional assembly units may also be embodied by means of the digital computer, for which only a modification of the software is necessary.

The present invention will be described below on the basis of a preferred embodiment with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional view of an embodiment of the ball and socket joint according to the present invention;

FIG. 2 is a schematic view of the embodiment according to FIG. 1 in the deflected state;

FIG. 3 is a schematic view of the embodiment according to FIG. 1 in a non-worn state;

FIG. 4 is a schematic block diagram of an analyzing means for the embodiment according to FIG. 1;

FIG. 5 is a schematic view of the embodiment according to FIG. 1 in a worn state; and

FIG. 6 is a schematic view of a wheel suspension for a motor vehicle with a ball and socket joint according to the embodiment shown in FIG. 1.

### DESCRIPTION OF THE PREFERRED EMBODIMENTS

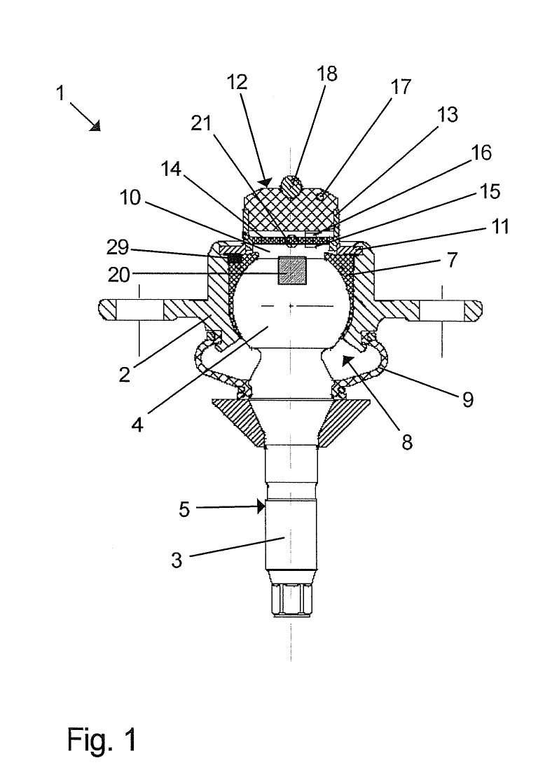

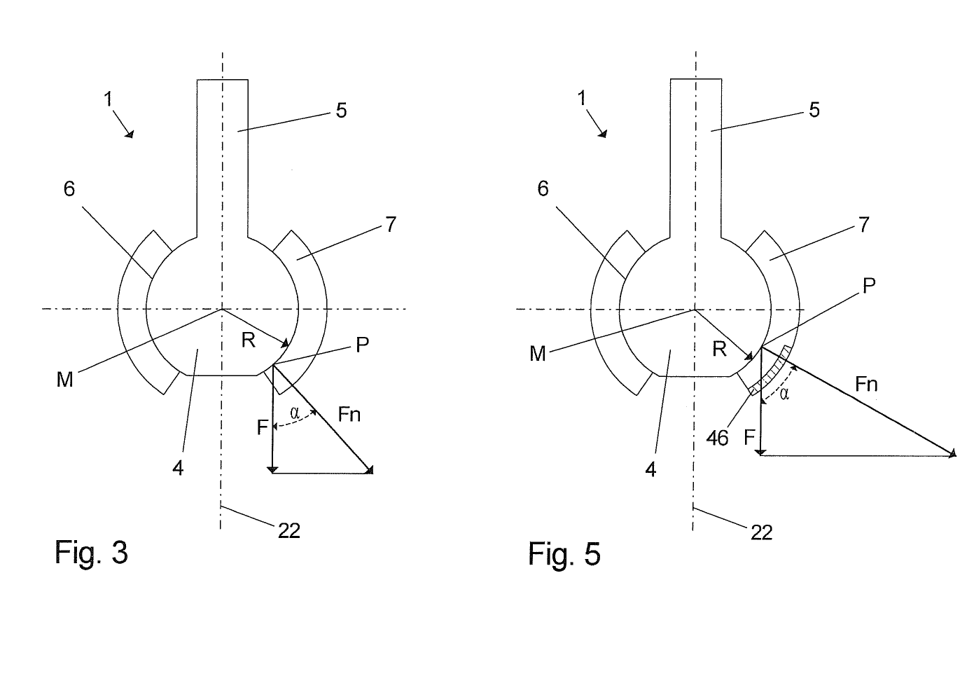

Referring to the drawings in particular, FIG. 1 shows an embodiment of a ball and socket joint 1 according to the present invention, which has a ball and socket joint housing 2 and a ball pivot 5 comprising a pin 3 and a joint ball 4 connected to this. A ball shell 7, which has a spherical bearing surface 6 (see FIG. 3) and in which the ball pivot 5 with its joint ball 4 is mounted rotatably and pivotably, is arranged in the joint housing 2. The ball and socket joint housing 2 has an opening 8, through which the ball pivot 5 extends. Furthermore, a sealing bellows 9, which extends up to the ball pivot 5 and is sealingly in contact with same, is fastened in the area of the opening 8.

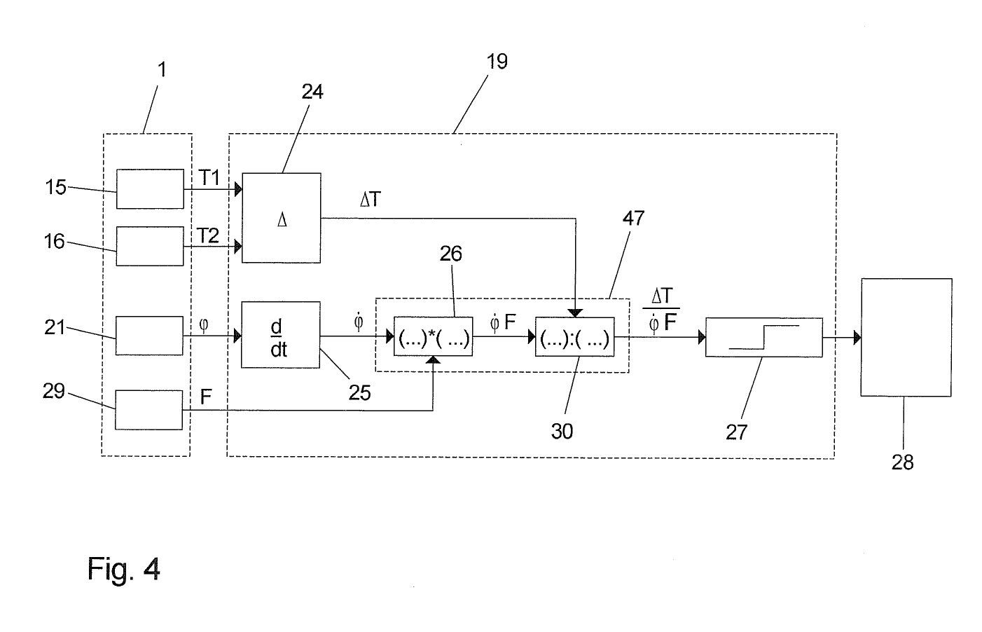

On the side located opposite the opening 8, the joint housing 2 has a bottom 11, which is provided with an opening 10, which opening 10 is closed by a cover 12. The cover 12 comprises a ring-shaped bracket 13, which is fastened to the joint housing 2 and carries a printed circuit board 14, on which two temperature sensors 15 and 16 are seated, the temperature sensor 15 being fastened on a side facing the joint ball 4 and the temperature sensor 16 on a side of the printed circuit board 14 facing away from the joint ball. On the side of the printed circuit board 14 facing away from the joint ball 4, the ring-shaped bracket 13 is closed with a pourable sealing compound 17, from which an electric line 18, which is connected to the two temperature sensors 15 and 16 and by means of which the two temperature sensors 15 and 16 are connected to an analyzing means 19 (see FIG. 4), is lead out.

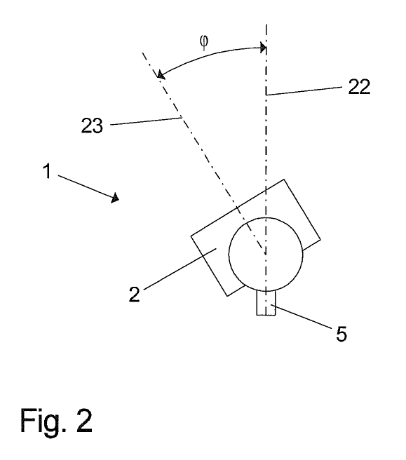

A magnet 20, which cooperates with a magnetic field-sensitive sensor 21 arranged on the printed circuit board 14, is arranged in the joint ball 4, the sensor 21 forming, together with the magnet 20, an angle measuring device, by means of which a twisting and/or pivoting angle φ (see FIG. 2) of the ball pivot 5 relative to the joint housing 2 can be detected. The magnetic field-sensitive sensor 21 is connected to the analyzing means 19 via the electric line 18.

A force sensor 29, which can determine the force F (see FIG. 3), which is exerted by the ball pivot 5 on the housing 2 or on the ball shell 7 and which is measured preferably in or in parallel to the direction of the longitudinal axis 23 (see FIG. 2) of the housing 2, is provided between the ball shell 7 and the housing 2 or the bottom 11. The force sensor 29 is connected to the analyzing means 19 via the electric line 18. As an alternative, the force sensor 29 may also be arranged between the ball shell 7 and the ball pivot 5 or outside the joint 1, or it may be eliminated altogether in a simpler embodiment of the ball and socket joint.

FIG. 2 schematically shows the angle φ between the longitudinal axis 22 of the ball pivot 5 and the longitudinal axis 23 of the joint housing 2. As an alternative or in addition, it is possible that the measured angle φ represents the twisting of the ball pivot 5 in relation to the joint housing 2 about its longitudinal axis 22.

FIG. 3 shows a schematic view of the non-worn ball and socket joint 1, where the force F is exerted by the ball pivot 5 on the ball shell 7 in an area or point P of the highest load in the loaded state of the ball and socket joint 1. Component Fn of the force F is directed especially at right angles to the spherical bearing surface 6 of the ball shell 7 and forms an angle α with the force F. The force component Fn designated as the normal force is preferably located on a straight line, which passes through the center M of the spherical bearing surface 6 having the center M. The center M is, in particular, also the center of the joint ball 4 and the radius R is also the radius thereof (of the joint ball).

A process, by means of which a value characterizing the wear of the ball and socket joint 1 can be determined, will be described below. The amount of heat q produced in the joint by friction increases due to hardening of the lubricating grease introduced into the ball and socket joint housing 2 and/or due to wear of the ball shell 7. An increased amount of heat q is an indicator of increased wear, and the amount of heat q generated by friction is eliminated, among other things, via the printed circuit board 14 installed in the joint. By measuring the temperature T2 above the printed circuit board 14 by means of the temperature sensor 16 and the temperature T1 below the printed circuit board 14 by means of the temperature sensor 15, the heat flux [symbol] flowing through the printed circuit board 14 can be calculated as:

[symbol]

=k1·ΔT, with ΔT=(T2−T1).

### Here,

is the derivative of the amount of heat over time,
ΔT is the temperature difference between the top side and the underside of the printed circuit board 14, and [symbol]
   K1 is a joint-specific constant. On the other hand, the friction output [symbol] produced in the joint can be calculated as

$$\dot{q} = \frac{Fr \cdot s}{t}$$

in which Fr designates the frictional force, s the friction and t the time. The frictional force Fr is equal here to the product of the normal force Fn and the coefficient of friction μ, and

$$Fn = \frac{F}{cos α} , \\ with$$

$$Fr = μ \cdot Fn$$

applies to the normal force Fn.

In particular, the normal force Fn may be greater, e.g., because of notch effects, than the force F, where α is the angle between the force vector F and the normal force Fn. The quotient of the path s and the time t corresponds to the velocity of rotation and tilting v of the ball pivot 5, which velocity is, furthermore, equal to the product of the angular velocity φ of the ball pivot 5 in relation to the ball shell 7 or the housing 2 and the friction radius Rr, which is formed by the product of the ball pivot radius R and sin α, so that

v=φ·R·sin α.

applies to the velocity of rotation and tilting v of the ball pivot 5.

### With

$$v = \frac{s}{t} ,$$

$$\dot{q} = \frac{Fr \cdot s}{t} = μ \cdot F \cdot \dot{ϕ} \cdot R \cdot tan α$$

is then obtained for the friction output.

From this follows:

$$μ \cdot tan α = \frac{Δ T \cdot K 1}{F \cdot R \cdot \dot{ϕ}} ,$$

in which the term μ·tan α forms a suitable wear indicator for the ball and socket joint 1.

However, since the variables K1 and R are joint-dependent constants, these can also be omitted in the determination of the wear indicator, so that the value I, with

$$I = \frac{Δ T}{F \cdot \dot{ϕ}} ,$$

is also a suitable wear indicator for the ball and socket joint 1. In a simpler variant of the ball and socket joint, the force is assumed to be a constant and can therefore be omitted in the determination of the wear indicator. This simplified wear indicator Iᵥ is thus obtained as follows:

$${I}_{v} = \frac{Δ T}{\dot{ϕ}} .$$

The wear indicator μ·tan α or I can be determined with the detection of the temperature difference ΔT, the velocity of rotation \acute{φ} of the ball pivot 5 as well as the external force F. The external force F and/or the velocity of rotation \grave{φ} of the ball pivot 5 can be measured or determined with sensors arranged outside the joint 1. However, the force sensor 29 and/or the angle measuring device 20, 21 are preferably arranged in the joint 1 and are integrated in same.

If the wear indicator μ·tan α or I exceeds a preset threshold value, the ball and socket joint 1 should be checked more closely and possibly replaced. If the angle α is also measured by means of suitable sensors in case of a favorable ball and socket joint design, it is, furthermore, possible to make a distinction between the hardening of the grease (change in μ) and wear of the shell (change in α).

FIG. 4 shows a schematic block diagram of the analyzing means 19, where a difference former 24 is connected to the two temperature sensors 15 and 16 and yields the temperature difference ΔT as an output signal. A differentiator 25 is connected to the angle measuring device or to the magnetic field-sensitive sensor 21 and yields the angular velocity \grave{φ} as the output signal. The difference former 24 and the differentiator 25 are followed downstream by a calculating unit 47, which is connected to the force sensor 29 and which yields the wear indicator I as the output signal. In addition, it is possible to multiply the value I by K1 and divide by R in order to obtain the term μ·tan α.

According to FIG. 4, the calculating unit 47 has a multiplier 26, which is arranged downstream of the differentiator 25, is connected to the force sensor 29 and yields the product \acute{φ}·F as an output variable. The calculating unit 47 has, furthermore, a divider 30, which is arranged downstream of the multiplier 26 and the difference former 24 and yields the value I as an output signal.

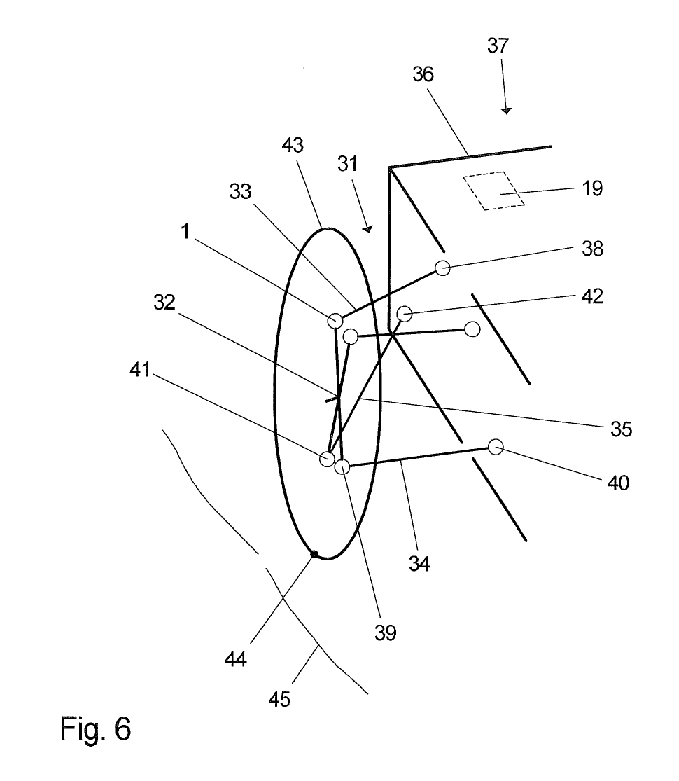

The wear indicator I or μ·tan α determined may be sent to a threshold value transducer 27, which is formed by the analyzing means 19 here and by which a signal transmitter 28 arranged downstream of this threshold value transducer can be actuated. The signal transmitter 28, which is arranged especially in the passenger compartment of a vehicle 37 (see FIG. 6), may be designed as an audio or visual signal transmitter in order to inform the driver of the wear of the ball and socket joint 1 in case the permissible wear or the threshold value is exceeded. For example, a light is suitable for use as a visual signal transmitter. It is possible as an alternative that the wear value I or μ·tan α or the output signal of the threshold value transducer 27 is sent to a vehicle control. Since the angular velocity \grave{φ} may have different signs depending on the direction of rotation or pivoting of the ball pivot 5, it is possible to provide an absolute value transducer, which is arranged, e.g., downstream of the calculating unit 47 and is optionally arranged upstream of the threshold value transducer. The absolute value transducer sends as the output signal the (absolute) value of the signal sent to it and may also be provided between the differentiator 25 and the calculating unit 47 or integrated in these. Furthermore, it is possible to calculate the temperature difference ΔT with ΔT=(T1−T2).

FIG. 4 shows only an example of the analyzing means 19, which shall not be interpreted as a limiting example. In particular, the combination of the multiplier 26 and the divider 30 may be replaced by an equivalent assembly unit or calculating unit, which comprises, e.g., two consecutive dividers. Even though it is possible to build up the analyzing means 19 from analog or digital assembly units, the analyzing means 19 is formed especially by a digital computer or by a software running in this according to the embodiment, in which case the wear indicator I or μ·tan α is calculated numerically or determined from the signals T1, T2, φ and F (optionally with the constants K1 and R).

FIG. 5 shows a schematic view of the ball and socket joint 1 in the worn state, where wear is associated with a change in the angle α. The area or point P of the highest load thus migrates with increasing wear of the ball and socket joint 1. The area or point P migrates practically only slightly, so that the view according to FIG. 5 should be considered to be only schematic to illustrate this migration.

While the area or point P can still be determined or calculated in a testing field in the non-worn state (see FIG. 3), additional sensors may be provided in the ball and socket joint 1 in the worn state (see FIG. 5) for the accurate determination of the area or point P. For example, a plurality of force sensors or a force sensor array 46 formed by these may be arranged in the joint housing 2 or in the ball shell 7 and they can detect the area or point P. However, this is necessary only when higher accuracy is required for the determination of the wear value I or μ·tan α. Distinction can also be made in this case between wear of the shell and hardening of the grease.

An incipient wear and/or an incipient hardening of the grease can be recognized early by the measurement of the “wear indicator.” Damage to the ball and socket joint 1 is detected early, before failure and situations that are critical for safety develop. The electronic system and the temperature sensors can be fully protected against harmful substances and they can be combined with other sensors.

FIG. 6 shows a schematic view of a wheel suspension 31, where a wheel carrier 32 is connected to a vehicle body 36 of the motor vehicle 37, which is shown partially, via an upper suspension arm 33, a lower suspension arm 34, and a radius arm 35. The upper suspension arm 33 is connected to the wheel carrier 32 via the ball and socket joint 1 according to the present invention and to the vehicle body 36 via a joint or elastomer bearing 38. The lower suspension arm 34 is connected to the wheel carrier 32 via a ball and socket joint 39 and to the vehicle body 36 via an elastomer bearing 40. Furthermore, the radius arm 35 is connected to the wheel carrier 32 via a ball and socket joint 41 and to the vehicle body 36 via an elastomer bearing 42. A tire or wheel 43, which is in contact with a road surface 45, shown schematically, in a wheel contact point 44, is mounted rotatably on the wheel carrier 32. Furthermore, an analyzing means 19 is arranged in the vehicle body 36.

Wear measurement of the ball and socket joint 1 is carried out in the wheel suspension 31 being shown. In addition or as an alternative, it is possible to carry out such a measurement for one or more of the other ball and socket joints of the wheel suspension 31 as well.

While specific embodiments of the invention have been shown and described in detail to illustrate the application of the principles of the invention, it will be understood that the invention may be embodied otherwise without departing from such principles.

### List of Reference Numerals

1 Ball and socket joint
2 Joint housing
3 Pin
4 Joint ball
5 Ball pivot
6 Spherical bearing surface of the ball shell
7 Ball shell
8 Opening in the joint housing
9 Sealing bellows
10 Opening in bottom
11 Bottom
12 Cover
13 Bracket
14 Printed circuit board
15 Temperature sensor
16 Temperature sensor
17 Pourable sealing compound
18 Line
19 Analyzing means
20 Magnet
21 Magnetic field-sensitive sensor
22 Longitudinal axis of ball joints
23 Longitudinal axis of joint housing
24 Difference former
25 Differentiator
26 Multiplier
27 Threshold value transducer
28 Signal transmitter
29 Force sensor
30 Divider
31 Wheel suspension
32 Wheel carrier
33 Upper suspension arm
34 Lower suspension arm
35 Radius arm
36 Vehicle body
37 Motor vehicle
38 Joint or elastomer bearing
39 Ball and socket joint
40 Elastomer bearing
41 Ball and socket joint
42 Elastomer bearing
43 Wheel
44 Wheel contact point
45 Road surface
46 Force sensor array
47 Calcualting unit
φ Angle between ball pivot and joint housing
P Area of point of highest load
F Force
Fn Normal Force
M Center of the spherical bearing surface or joint ball
R Radius of the spherical bearing surface or joint ball

1-15. (canceled)

16. A ball and socket joint for a motor vehicle, ball and socket joint comprising:
a joint housing;
a ball pivot mounted rotatably and pivotably in said joint housing, said ball pivot being in contact with said joint housing or with a ball shell arranged between said joint housing and said ball pivot;
an angle measuring device for detecting an angle of said ball pivot relative to said joint housing; and
at least two temperature sensors arranged at spaced locations from one another in or on said joint housing.

17. A ball and socket joint in accordance with claim 16, wherein a frictional heat flux is generated by a motion of the ball pivot in relation to said joint housing, and said temperature sensors are seated in different positions in said frictional heat flux.

18. A ball and socket joint in accordance with claim 16, wherein said ball pivot has a pin and a joint ball connected to same, wherein said two temperature sensors are arranged at different distances from a center of said joint ball.

19. A ball and socket joint in accordance claim 16, further comprising a plate or printed circuit board arranged in or on said joint housing wherein said two temperature sensors are seated on mutually opposite sides of said plate or printed circuit board.

20. A ball and socket joint in accordance with claim 19, wherein said joint housing has a bottom and an opening located opposite said bottom, said ball pivot extending through t said opening, said plate or printed circuit board being arranged in the area of said bottom.

21. A ball and socket joint in accordance with claim 20, further comprising a cover wherein said bottom has an opening closed by said cover, wherein said cover has said plate or printed circuit board or comprises said plate or printed circuit board.

22. A ball and socket joint in accordance claim 16, wherein said angle measuring device is arranged in said ball and socket joint housing.

23. A ball and socket joint in accordance claim 16, further comprising a force sensor, wherein a force exerted by said ball pivot on said joint housing or on said ball shell is determined by said force sensor.

24. A ball and socket joint in accordance with claim 23, wherein said force sensor is arranged in said ball and socket joint housing.

25. A ball and socket joint in accordance claim 16, further comprising analyzing means for determining a wear indicator characterizing wear of said ball and socket joint, wherein said two temperature sensors and said angle measuring device are connected to said analyzing means.

26. A ball and socket joint in accordance with claim 25, wherein said analyzing means has a differentiator connected to said angle measuring device, a difference former connected to said two temperature sensors and a calculating unit arranged downstream of said differentiator and said difference former.

27. A ball and socket joint in accordance with claim 25, wherein said analyzing means is formed by at least one said digital computer.

28. A process for determining a wear indicator characterizing wear of a ball and socket joint, the process comprising the steps of:
providing a joint housing;
providing a ball pivot mounted rotatably and pivotably in said joint housing, said ball pivot being in contact with said joint housing or with a ball shell arranged between said joint housing and said ball pivot;
providing an angle measuring device for detecting an angle of said ball pivot relative to said joint housing; and
arranging at least two temperature sensors at spaced locations from one another in or on said joint housing
determining angle data by consecutive measurement of said angle between said ball pivot and said joint housing;
determining a velocity by differentiating the angle data over time;
measuring temperatures at least two different sites in or on said ball and socket joint; and
determining the wear indicator on the basis of said velocity and said temperatures.

29. A process in accordance with claim 28, wherein said wear indicator is multiplied by a joint-specific constant and divided by a radius of a joint ball of said ball pivot.

30. A process in accordance with claim 28, wherein a force exerted by said ball pivot on said joint housing or on a ball shell arranged between said ball pivot and said joint housing is measured and the wear indicator is additionally determined on the basis of said force.

31. A ball and socket joint for a motor vehicle, ball and socket joint comprising:
a joint housing with a bottom and an opening located opposite said bottom;
a ball pivot including a joint ball and a pin extending through said opening, said joint ball being mounted rotatably and pivotably in said joint housing;
a ball shell arranged between said joint housing and said ball pivot;
an angle measuring device for detecting an angle of said ball pivot relative to said joint housing;
a first temperature sensor in or on said joint housing; and
a second temperature sensor arranged in or on said joint housing at spaced location from said first temperature sensor wherein said two temperature sensors are arranged at different distances from a center of said joint ball, wherein a frictional heat flux is generated by a motion of the ball pivot in relation at least one of said ball shell and said joint housing, and said temperature sensors are seated in different positions in said frictional heat flux.

32. A ball and socket joint in accordance claim 31, further comprising further comprising:
a cover wherein said bottom has an opening closed by said cover, wherein said cover has a plate or printed circuit board or comprises a plate or printed circuit board and wherein said two temperature sensors are seated on mutually opposite sides of said plate or printed circuit board.

33. A ball and socket joint in accordance claim 31, further comprising a force sensor, wherein a force exerted by said ball pivot on said joint housing or on said ball shell is determined by said force sensor said force sensor being arranged in said ball and socket joint housing.

34. A ball and socket joint in accordance claim 31, further comprising analyzing means for determining a wear indicator characterizing wear of said ball and socket joint, wherein said two temperature sensors and said angle measuring device are connected to said analyzing means.

35. A ball and socket joint in accordance with claim 34, wherein said analyzing means has a differentiator connected to said angle measuring device, a difference former connected to said two temperature sensors and a calculating unit arranged downstream of said differentiator and said difference former.
